(19) United States
(12) Patent Application Publication
(10) Pub. No.: US 2004/0241551 A1
(43) Pub. Date: Dec. 2, 2004

(54) Element using polymer gel electrolyte

(76) Inventors: Seiji Nakamura, Osaka (JP); Masato Tabuchi, Osaka (JP); Takaaki Sakai, Osaka (JP); Katsuhito Miura, Osaka (JP); Satoshi Murakami, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/490,026

(22) PCT Filed: Sep. 20, 2002
(86) PCT No.: PCT/JP02/09699

(30) Foreign Application Priority Data
Sep. 21, 2001 (JP) 2001-288844

(51) Int. Cl. H01M 10/40; H01G 9/022

(52) U.S. Cl. 429/303; 252/62.2; 361/526

(57) ABSTRACT

A gel electrolyte, which is obtained by gelling a polyether polymer having polyethylene oxide and/or polypropylene oxide structure in main chain, obtained from an oxirane compound and having a weight-average molecular weight of 50,000 to 1,000,000 and a crosslinking agent with a polymerization initiator and heat in the presence of an electrolyte salt compound and an aprotic organic solvent, is a high performance polymer gel electrolyte and can produce a battery, a capacitor and a photoelectric conversion element in good efficiency.

### FIELD OF THE INVENTION

The present invention relates to an application of a gel electrolyte containing a gel of a macromolecular ether compound having high ionic conductivity and an electrolytic solution. In addition, the present invention relates to a polymer electrolyte battery, a capacitor, a photoelectric conversion element, and solar battery and a photosensor comprising the photoelectric conversion element, each of which has a positive electrode, a negative electrode and a gel electrolyte.

### BACKGROUND OF THE INVENTION

Hitherto, as an electrolyte constituting the lithium battery, used are carbonate compounds such as propylene carbonate, ethylene carbonate, butylene carbonate and γ-butyrolactone in view of ionic conductivity. There is the problem that a liquid leakage possibly damages instruments. Accordingly, a polymer solid electrolyte comprising an ether polymer having high ionic conductivity without using an electrolyte liquid is reported (e.g., JP-A-02-235957, JP-A-09-324114, and WO97/42251). However, a usable lowest temperature is high and the operation at −20° C. is impossible. Thus, the polymer solid electrolyte is used in a large instrument application such as an electric power storage and an electric automobile. The replacement of a lithium battery in a cellular phone and a personal computer requires the improvement of low temperature properties.

As a means for solving said problem, developed is a gel polymer solid electrolyte comprising a porous PVdF (polyvinylidene fluoride) copolymer and a liquid electrolyte. In the gel polymer solid electrolyte, the electrolyte solution is restricted in the polymer gel so that the leakage and drying up of the liquid are improved. However, the strength of the polymer of keeping the liquid is low and it is necessary to increase a polymer concentration to some degree. In addition, because the porous PVdF copolymer itself does not have the ionic conductivity, the battery performance is poor in comparison with a currently used lithium battery.

Recently as a means for solving such problem, developed is a gel polymer solid electrolyte comprising both the liquid electrolyte and the polymer solid electrolyte. Examples of a method of incorporating the gel electrolyte into the battery include 1) a method comprising using a previously crosslinked polymer instead of or together with a separator to prepare a battery construction, injecting an electrolyte solution into the battery construction, and perform the swell, 2) a method comprising immersing a crosslinked polymer film in an electrolyte solution to swell the crosslinked polymer film and then incorporating the film into a battery, and 3) a method comprising preparing previously a battery construction which is the same as an ionic battery, injecting a pregel solution comprising a polymer, an electrolyte salt, an electrolyte solution, a crosslinking agent and a initiator into the battery construction, and then performing the heat-curing.

The methods 1) and 2) has the problem that the control of the size change of the polymer after the swell is difficult and the handling and the operation are difficult. The method 3) has the advantages that the remodeling of a current lithium ion battery preparation plant is minimum and that the above-mentioned problem is dissolved. The gel polymer solid electrolyte battery using the method 3) is actively researched (e.g., JP-A-07-326383, JP-A-09-23 199, JP-A-10-74526 and JP-A-11-214038).

The method 3) requires that the viscosity of the pregel is decreased to the viscosity of enabling the liquid injection and that the gelation reaction proceeds in the battery. A conventional procedure reacts a reactive monomer having a low molecular weight of a few hundreds to a few thousands, but the complete performance of the reaction is very difficult. If an unreacted monomer having low molecular weight is present in the battery, the battery has the remarkably deteriorated properties. Accordingly, the addition amounts of the initiator and the reactive monomer are limited (JP-A-11-214038). The control of an oxygen concentration is important and the necessity of the addition of an oxygen absorbing agent is pointed out (JP-A-05-3036 and JP-A-2001-6740).

### SUMMARY OF THE INVENTION

The present inventors consider the above problems and provide a means for producing a high-performance polymer gel electrolyte, and a battery, a capacitor and a photoelectric conversion element in good efficiency.

In order to achieve the above-mentioned object, a gel polymer solid electrolyte is prepared by crosslinking a polyether polymer having a high molecular weight, and a crosslinking agent efficiently forming a network structure, in the presence of an electrolyte salt compound and an organic solvent. Usually, if the molecular weight is high, the viscosity rapidly increases so that an injection operation is difficult. Because the crosslinked product of the polyether polymer has a very high property of keeping an electrolyte solvent, it is possible to increase the amount of the electrolyte solvent to a maximum limitation so that the problem of viscosity is dissolved. Accordingly the present inventors completed the present invention.

Because the polyether polymer itself has a high ionic conductivity, the resultant gel electrolyte has a high ionic conductivity. When the gelation is performed with using the polyether polymer, the gelation gives a gel which rapidly deforms by an external pressure and returns to an original shape by the elimination of the external pressure. Since the liquid leakage is not caused, the gel electrolyte is useful as an electrolyte for a thin lithium battery, solar battery, capacitor (electricity storage instrument utilizing static electricity) and photoelectric conversion element comprising an aluminum laminate. The detail of the capacitor is explained in JP-A-2002-203749, and the detail of the photoelectric conversion element is explained in WO00/54361.

The gelation reaction can be performed under a wide range of conditions (temperature and reaction time) by optimizing the crosslinking agent and the composition to produce efficiently the battery, the capacitor and the photoelectric conversion element. That is, the present invention provides the element having excellent productivity and long-term stability (for example, a battery, a capacitor, a photoelectric conversion element, a solar battery and a sensor) by using the electrolyte having very high ionic conductivity and excellent stability.

### DETAILED EXPLANATION OF THE INVENTION

Because the present invention produces the gel by crosslinking, as a starting material, the macromolecular compound having high compatibility with the electrolyte solution, the property of keeping the electrolyte solution is very high in comparison with a conventional composite material wherein a liquid is kept in a porous polymer and a conventional gel prepared by polymerizing a low molecular weight compound. Accordingly, the gel electrolyte can be applied to, for example, a lithium battery and a photoelectric element having high long-term stability and reliability. Because the polymer itself is rubbery and has high ionic conductivity in the present invention, the resultant gel electrolyte has a high ionic conductivity and a good electric connection. The gel electrolyte of the present invention can be applied to an electrochemical element which requires an efficient transportation of ion.

The gel electrolyte according to the present invention is generated from a polyether polymer, a crosslinking agent forming a network structure, an electrolyte salt compound, an aprotic organic solvent and a polymerization initiator.

In the present invention, the network structure containing a large amount of the organic solvent can be formed by performing a partial crosslink based on a polyether polymer having a large molecular weight. This network structure has a high effect of confining the organic solvent in the network so that the network structure is non-flowed in the state of keeping the organic solvent. In the present invention, the electrolyte comprising the polymer forming the network structure is referred to as “gel electrolyte”.

Examples of a method of preparing the gel battery include 1) a method comprising using a previously crosslinked polymer instead of or together with a separator to prepare a battery construction, injecting an electrolyte solution into the battery construction, and perform the swell, 2) a method comprising immersing a in an electrolyte solution to swell the crosslinked polymer film and then incorporating the film into a battery, and 3) a method comprising preparing previously a battery construction which is the same as an ionic battery and which comprises a positive electrode, a separator and negative electrode, injecting a pregel solution comprising a polymer, an electrolyte salt, an electrolyte solution, a crosslinking agent and a initiator into the battery construction, and then performing the heat-curing.

The methods 1) and 2) has the problem that the control of the size change of the gel electrolyte after the swell is difficult, and the handlability and the evaporation of the solvent at the handling are problematic. The method 3) (referred to as “pregel injection method”) has the advantages that the remodeling of a current lithium ion battery preparation plant is minimum and that the above-mentioned problem is dissolved. The method 3) requires that the viscosity of the pregel is decreased to the viscosity of enabling the liquid injection and that the gelation reaction proceeds in the battery. In a conventional pregel injection method, it is important that how a reactive monomer having a low molecular weight of a few hundreds to a few thousands is reacted in good efficiency, and therefore the organic peroxide and the reactive monomer are limited.

The present inventors intensively studied, and discovered that a very high property of keeping an electrolyte solution by a gel electrolyte is achieved by basing on a polyether polymer having a high ionic conductivity and a weight-average molecular weight of 50,000 to 1,000,000, a pregel composition (particularly a pregel solution) having a viscosity of at most 100 mPa.s can be easily formed by optimizing ingredients, and the pregel composition can efficiently gel/reacts to give the gel electrolyte.

In the present invention, the polyether polymer is preferably a polyether polymer which itself swells with an electrolyte solution and exhibits the ionic conductivity.

The present invention relates to an element comprising a gel electrolyte obtained by reacting a pregel composition having a viscosity of at most 100 mPa.s at 25° C. comprising:

(A)

(i) a polyether polymer having a weight-average molecular weight of 50,000 to 1,000,000 and obtained by polymerizing at least one oxirane compound having ethylene oxide and/or propylene oxide in a main chain and optionally having a oligoalkylene oxide chain structure in a side chain, and/or

(ii) a polyether polymer having a weight-average molecular weight of 50,000 to 1,000,000 and obtained by copolymerizing at least one oxirane compound having ethylene oxide and/or propylene oxide in a main chain and optionally having a oligoalkylene oxide chain structure in a side chain, and at least one oxirane compound having a reactive functional group,

(B) a crosslinking agent,

(C) an electrolyte salt compound,

(D) an aprotic organic solvent, and

(E) a polymerization initiator, wherein the element is prepared by injecting the pregel composition into an element construction having a positive electrode and a negative electrode which are opposed, and gelling the pregel composition by a crosslinking reaction, and the gel, in which the concentration of the polyether polymer (A) is from 0.5 to 10% by weight based on the gel electrolyte, is sandwiched between the positive electrode and the negative electrode.

In the present invention, examples of the element are a battery (or a cell), a capacitor, a sensor, an optical element (for example, a photoelectric conversion element, a solar battery and a photosensor).

The oxirane compound having ethylene oxide and/or propylene oxide in a main chain has at least one selected from ethylene oxide and propylene oxide. That is, the oxirane compound contains either of ethylene oxide or propylene oxide, or both of ethylene oxide and propylene oxide.

When both ethylene oxide and propylene oxide are contained, a molar ratio of ethylene oxide to propylene oxide is preferably from 50:50 to 95:5, more preferably from 70:30 to 90:10.

The oxirane compound having ethylene oxide and/or propylene oxide in main chain preferably has an oligoalkylene oxide chain structure in a side chain. The oxirane compound having oligoalkylene oxide chain structure may be of the formula (1):

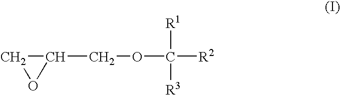

wherein R¹, R² and R³ are a hydrogen atom or —CH₂O(CH₂CH₂O)ₙR (n and R may be different among R¹, R² and R³) provided that all of R¹, R² and R³ are not simultaneously a hydrogen atom (R is a group selected from an alkyl group having I to 12 carbon atoms, an alkenyl group having 2 to 8 carbon atoms, a cycloalkyl group having 3 to 8 carbon atoms, an aryl group having 6 to 14 carbon atoms and an aralkyl group having 7 to 12 carbon atoms. n is from 1 to 12.)

In order to give a crosslinking reactivity to the above-mentioned polymer, it is preferable to copolymerize a monomer having a reactive functional group such as a methacrylate group, an acrylate group, a vinyl group and an allyl group. Such reactive group-containing monomer may be a monomer having one epoxy group and one at least one reactive functional group. The reactive functional group may be (a) a reactive silicon group, (b) a methyl epoxy group, and (c) an ethylenically unsaturated group.

The polyether polymer can be prepared from a glycidyl compound having an ethylene oxide and/or propylene oxide unit in main chain and optionally an oligoalkylene oxide group in a side chain. In some cases, the polyether polymer may be prepared by copolymerizing the above-mentioned glycidyl compound and reactive functional group-containing glycidyl compound.

The oligoalkylene oxide group-containing glycidyl compound may be a compound of the formula (2):

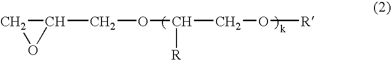

wherein R is a hydrogen atom or a methyl group, R′ is an alkyl group having 1 to 12 carbon atoms, an alkenyl group having 2 to 8 carbon atoms, a cycloalkyl group having 3 to 8 carbon atoms, an aryl group having 6 to 14 carbon atoms or an aralkyl group having 7 to 12 carbon atoms, and k, that is, the polymerization degree of oxyalkylene units in the side chain, is from 1 to 12.

Examples of the oligoalkylene oxide group-containing glycidyl compound include, for example, 2-(2-methoxyethoxy)ethyl glycidyl ether and 2-methoxyethyl glycidyl ether.

In the reactive functional group-containing oxirane compound, the reactive functional group is (a) a reactive silicon group, (b) a methyl epoxy group and/or (c) an ethylenically unsaturated group. This oxirane compound has at least one reactive functional group selected from the group consisting of (a) the reactive silicon group, (b) the methyl epoxy group, and (c) the ethylenically unsaturated group.

Examples of the monomer wherein the reactive functional group is (a) the reactive silicon group are as follows:

1-glycidoxymethyltrimethoxysilane, 1-glycidoxymethylmethyldimethoxysilane,

2-glycidoxyethyltrimethoxysilane, 2-glycidoxyethylmethyldimethoxysilane,

3-glycidoxypropylmethyldimethoxysilane, 3-glycidoxypropyltrimethoxysilane,

4-glydoxybutylmethyldimethoxysilane, 4-glycidoxybutylmethyltrimethoxysilane,

6-glycidoxyhexylmethyldimethoxysilane and 6-glycidoxyhexylmethyltrimethoxysilane;

3-(1,2-epoxy)propyltrimethoxysilane, 3-(1,2-epoxy)propylmethyldimethoxysilane,

3-(1,2-epoxy)propyldimethylmethoxysilane, 4-(1,2-epoxy)butyltrimethoxysilane,

4-(1,2-epoxy)butylmethyldimethoxysilane, 5-(1,2-epoxy)pentyltrimethoxysilane,

5-(1,2-epoxy)pentylmethyldimethoxysilane, 6-(1,2-epoxy)hexyltrimethoxysilane and

6-(1,2-epoxy)hexylmethyldimethoxysilane;

1-(3,4-epoxycyclohexyl)methyltrimethoxysilane,

1-(3,4epoxycyclohexyl)methylmethyldimethoxysilane,

2-(3,4epoxycyclohexyl)ethyltrimethoxysilane, 2-(3,4-epoxycyclo-hexyl)ethylmethyldimethoxysilane,

3-(3,4-epoxycyclohexyl)propyltrimethoxysilane,

3-(3,4-epoxycyclohexyl)propylmethyldimethoxysilane, 4-(3,4-epoxycyclohexyl)butyl-trimethoxysilane and 4-(3,4-epoxycyclohexyl)butylmethyldimethoxysilane.

Examples of the monomer wherein the reactive finctional group is (b) the methyl epoxy group are as follows:

2,3-epoxypropyl-2′,3′-epoxy-2′-methylpropyl ether, ethyleneglycol-2,3-epoxypropyl-2′,3′-epoxy-2′-methylpropyl ether and diethyleneglycol-2,3-epoxypropyl-2′,3′-epoxy-2′-methylpropyl ether; and

2-methyl- 1,2,3,4-diepoxybutane, 2-methyl-1,2,4,5-diepoxypentane, and

2-methyl-1,2,5,6-diepoxyhexane; and hydroquinone-2,3-epoxypropyl-2′,3′-epoxy-2′-methylpropyl ether, and cathecol-2,3-epoxypropyl-2′,3′-epoxy-2′-methylpropyl ether.

Examples of the monomer wherein the reactive finctional group is (c) the ethylenically unsaturated group are as follows: allyl glycidyl ether, 4-vinyl cyclohexyl glycidyl ether, α-terpinyl glycidyl ether, cyclohexenyl methyl glycidyl ether, p-vinyl benzyl glycidyl ether, allyl phenyl glycidyl ether, vinyl glycidyl ether, 3,4-epoxy-1-butene, 3,4-epoxy-1-pentene, 4,5-epoxy-2-pentene, 1,2-epoxy-5,9-cyclododecadiene, 3,4-epoxy-1-vinylcyclohexene, 1,2-epoxy-5-cyclooctene, glycidyl acrylate, glycidyl methacrylate, glycidyl sorbate, glycidyl cinnamate, glycidyl crotonate, glycidyl 4-hexenoate, oligoethylene glycol glycidyl ether acrylate having 1 to 12 oxyethylene chains, oligoethylene glycol glycidyl ether methacrylate having 1 to 12 oxyethylene chains, and oligoethylene glycol allyl glycidyl ether having 1 to 12 oxyethylene chains.

An organotin-phosphate ester condensate material is preferably used as a catalyst in respect of preparing the above-mentioned base polymer having high ionic conductivity.

In the polyether polymer, the amount of the reactive functional group-containing glycidyl compound may be at most 30 parts by weight, e.g., from 0.5 to 20 parts by weight, for example, from 1 to 10 parts by weight, particularly from 3 to 6 parts by weight, based on 100 parts by weight of the glycidyl compound optionally having the oligoalkylene oxide group.

The weight-average molecular weight of the polyether polymer in the present invention is measured by a gel permeation chromatography (GPC) (in terms of standard polystyrene). The weight-average molecular weight of the polyether polymer is from 50,000 to 1,000,000, for example, 100,000 to 500,000. If the weight-average molecular weight of the polyether polymer is smaller than 50,000, the sufficient mechanical strength cannot be obtained. If the weight-average molecular weight of the polyether polymer is larger than 1,000,000, the viscosity of the pregel solution at 25° C. is larger than 100 mPa.s so that the injection operation of pregel solution is difficult, and a resultant battery has low discharge capacity.

In the present invention, the concentration of the polyether polymer in the gel electrolyte is from 0.5 to 10% by weight. For the purpose of decreasing the viscosity of the pregel solution and in view of high ionic conductivity, the concentration of the polyether polymer is preferably from 1 to 5% by weight. If the concentration of the polyether polymer is at least 0.5% by weight, the resultant gel has high mechanical strength. If the concentration of the polyether polymer is at most 10% by weight the pregel composition (particularly, the pregel solution) has a low viscosity so that an injection operation of the pregel composition is easy, and the resultant battery has high discharge capacity.

The use of the crosslinking agent accelerates the gelation so that the mechanical strength of the resultant crosslinked polymer is improved. Examples of the crosslinking agent include a compound having a functional group such as a methacrylate group, an acrylate group, a vinyl group, an allyl group, an epoxy group, an isocyanate group and an imide group.

Examples of the crosslinking agent are as follows: ethylene glycol diacrylate, ethylene glycol dimethacrylate, oligoethylene glycol diacrylate, oligoethylene glycol dimethacrylate, propylene glycol diacrylate, propylene glycol dimethacrylate, oligopropylene glycol diacrylate, oligopropylene glycol dimethacrylate, 1,3-butylene glycol diacrylate, 1,4-butylene glycol diacrylate, 1,3-glycerol dimethacrylate, 1,1,1-trimethylol propane dimethacrylate, 1,1,1-trimethylol ethane diacrylate, 1,1,1-trimethylol propane trimethacrylate, 1,1,1-trimethylol ethane triacrylate, pentaerythritol trimethacrylate, 1,2,6-hexane triacrylate, sorbitol pentamethacrylate, methylene-bis-acrylamide, methylene-bis-methacrylarmide, divinylbenzene, vinyl methacrylate, vinyl crotonate, vinyl acrylate, vinyl acetylene, trivinyl benzene, triallyl cyanyl sulfide, divinyl ether, divinyl sulfoether, diallyl phthalate, glycerol trivinyl ether, allyl methacrylate, allyl acrylate, diallyl maleate, diallyl fumarate, diallyl itaconate, methyl methacrylate, butyl acrylate, ethyl acrylate, 2-ethyl hexyl acrylate, lauryl methacrylate, ethylene glycol acrylate, triallyl isocyanurate, N,N′-m-phenylene bismaleimide, N,N′-(4,4′-diphenylmethane) bismaleimide, bis(3-ethyl-5-methyl4-maleimidophenyl) methane, 2,2-bis[4-(4-maleimidophenoxy)phenyl]propane, p-quinone dioxime, maleic anhydride and itaconic acid.

Particularly, a maleimide-based crosslinking agent is preferable in view of the strength and electrochemical stability of the resultant gel.

The amount of the crosslinking agent is not limited. Usually, the amount of the crosslinking agent is from 0.1 to 30 parts by weight, for example, from 1 to 30 parts by weight, particularly from 5 to 25 parts by weight, based on 100 parts by weight of the branched polyether polymer.

A radical reaction of the polymer causes the crosslinking reaction to give the gel. The radical reaction can be performed by heat, light, electronic beam and an electrochemical method. When the gelation reaction is performed in a cell, an addition reaction without an elimination reaction is preferable. Examples of the polymerization initiator preferably used in the case that the gelation is performed by heat include an organic peroxide such as 1,1-bis(t-butylperoxy)-3,3,5-trimethyl cyclohexane, di-t-butyl peroxide, t-butyl cumyl peroxide, dicumyl peroxide and benzoyl peroxide; and an azo compound such as 2,2′-azobisisobutyronitrile and 2,2′-azobis(2,4-dimethylvaleronitrile).

When the gelation is performed in a battery, a capacitor and a photoelectric conversion element, the gelation is performed usually by the heat, In this case, a very high temperature cannot be used, it is preferable to select a polymerization initiator which completes the reaction at at most 80° C. within about one hour. Such polymerization initiator is an organic peroxide and an azo compound.

Examples of the organic peroxide include peroxyester, diacyl peroxide, dialkyl peroxide, hydroperoxide, peroxyketal and ketone peroxide, at least two of which can be used in combination.

Specific examples of the peroxyester include cumyl peroxy neodecanoate, 1,1,3,3-tetramethylbutyl peroxy neodecanoate, 1-cyclohexyl-1-methylethyl peroxy neodecanoate, t-hexyl peroxy neodecanoate, t-butyl peroxy neodecanoate, t-hexyl peroxypivalate, t-butyl peroxypivalate, t-hexyl peroxy-2-ethyl hexanoate, t-butyl peroxy-2-ethyl hexanoate, t-hexyl peroxyisopropyl monocarbonate, and t-hexyl peroxy benzoate.

Specific examples of the diacyl peroxide include m-toluoyl and benzoyl peroxide, benzoyl peroxide, lauroyl peroxide, octanoyl peroxide, isobutyl peroxide and 3,5,5-trimethyl hexanoyl peroxide.

Specific examples of the dialkyl peroxide include t-butylcumyl peroxide, di-t-butyl peroxide, and 2,5-dimethyl-2,5-bis(t-butyl peroxy)hexane-3.

Specific examples of the hydroperoxide include p-menthane hydroperoxide, 1,1,3,3-tetramethylbutylhydroperoxide, cumene hydroperoxide, and t-hexylhydro-peroxide.

Specific examples of the peroxy ketal include 1,1-bis(t-hexyl peroxy)-3,3,5-trimethylcyclohexane, 1,1-bis(t-hexyl peroxy)cyclohexane, and 1,1-bis(t-butyl peroxy)-2-methylcyclohexane.

Specific examples of the ketone peroxide include cyclohexanone peroxide, methylcyclohexanone peroxide, and methyl acetoacetate peroxide.

As the azo compound, those conventionally used for the cross-linking, such as azonitrile compounds, azoamide compounds and azoamidine compounds, can be used. Specific examples of the azo compound include 2,2′-azobisisobutyronitile,

2,2′-azobis(2-methylbutyronitrile), 2,2′-azobis(4-methoxy-2,4-dimethylvaleronitrile),

2,2′-azobis(2-methyl-N-phenylpropionamidine) dihydrochloride,

2,2′-azobis[2-(2-imidazolin-2-yl)propane],

2,2′-azobis[2-methyl-N-(2-hydroxyethyl)propionamide], 2,2′-azobis(2-methylpropane), and 2,2′-azobis[2-(hydroxymethyl)propionitrile].

The amount of the polymerization initiator is arbitrary, but usually is in the range of 0.01 to 5 parts by weight, for example, 0.1 to 2 parts by weight, based on 100 parts by weight of the total of the branched polyether polymer and the crosslinking agent.

The electrolyte salt compound used in the present invention is not limited so far as it is soluble in the pregel composition of the present invention. The following electrolyte salt compounds are preferably used. Compounds comprising a cation selected from metal cation, ammonium ion, amidinium ion and guanidium ion, and an anion selected from chlorine ion, bromine ion, iodine ion, perchlorate ion, thiocyanate ion, tetrafluoroborate ion, nitrate ion, AsF₆—, PF₆—, stearyl sulfonate ion, octyl sulfonate ion, dodecyl benzene sulfonate ion, naphthalene sulfonate ion, dodecyl naphthalene sulfonate ion, 7,7,8,8-tetracyano-p-quinodimethane ion, R¹²SO₃—, [(R¹²SO₂)(R¹³SO₂)N]—, [(R¹²SO₂)(R¹³SO₂)(R¹⁴SO₂)C]—, and (R¹²SO₂)(R¹³SO₂)YC—. R¹², R¹³, R¹⁴ and Y each is an electrophilic group. Preferably, R¹², R¹³ and R¹⁴ independently are a C₁ to C₆ perfluoroalkyl group or a C₆ to C₁₅ perfluoroaryl group, Y is a nitro group, a nitroso group, a carbonyl group, a carboxyl group, a cyano group or a trialkyl ammonium group. R¹², R¹³ and R¹⁴ may independently be the same or different.

The metal cation may be a cation of transition metal. The preferable type of the cation is different depending on the used application. For example, when the lithium battery is prepared by the method of the present invention, a lithium salt is preferably used as the added electrolyte salt compound. Particularly, when the lithium secondary battery is prepared, an electrochemically stable lithium salt is preferable as the electrolyte salt compound in view of a wide voltage range. Examples of the electrochemically stable lithium salt are a lithium fluoroalkylsufonate salt such as LiCF₃SO₃ and LiC₄F₉SO₃; a lithium sulfonylimide salt such as LiN(CF₃SO₂)₂; and LiBF₄, LiPF₆,LiClO₄ and LiAsF₆. At least two of the above-mentioned compounds in combination can be arbitrarily used as the electrolyte salt compound.

The amount (the molar concentration) of the used electrolyte salt compound is not limited and is preferably from 0.1 M to 10 M, for example, 0.2 M to 3 M, particularly from 0.5 M to 2 M.

As the aprotic organic solvent dissolving the electrolyte salt compound, the use is made of the known solvents conventionally used. Examples of the aprotic organic solvent include a cyclic carbonate such as propylene carbonate, ethylene carbonate, γ-butyrolactone and butylene carbonate; a chain or linear carbonate such as dimethyl carbonate, methyl ethyl carbonate and diethyl carbonate, which may be used alone or in combination of at least two. A mixture solvent between the above-mentioned carbonate and an ether solvent such as 1,2-dimethoxyethane and 1,2-diethoxyethane is also preferable.

The amount of the aprotic organic solvent may be from 100 to 20000 parts by weight, for example, from 500 to 10000 parts by weight, particularly from 1500 to 5000 parts by weight, based on 100 parts by weight of the total of the polyether polymer and the crosslinking agent.

The above-mentioned gel electrolyte is stable to an active material of the positive electrode and the lithium metal which is an active material of the negative electrode, and the lithium battery utilizing such property can be prepared. When the battery of the present invention is prepared in the form of the lithium primary battery, the active material of the positive electrode may include LiCoO₂, LiMn₂O₄ and the like. When the battery is prepared in the form of the lithium secondary battery, the active material of the positive electrode includes an inorganic material, for example, manganese oxide such as MnO₂; vanadium oxide such as V₂O₅ and V₆O₁₃; a lithium-cobalt double oxide represented by LiₓMO₂ (x is different depending on discharge-recharge state, and is usually from 0.05 to 1.10. M is a transition metal.); and a lithium-nickel double oxide; an organic material, for example, polyacene, polypyrene, polyaniline, polyphenylene, polyphenylene sulfide, polyphenylene oxide, polypyrole and polyazulene. Examples of the active material of the negative electrode include a lithium metal, a lithium-aluminum alloy, a lithium-lead alloy, an interlayer compound wherein lithium is occluded between graphite or carbon layers.

The pregel composition is poured into the element construction, that is, between the positive electrode and negative electrode, and gelled by the crosslinking reaction to form the element. In the case of the battery, a porous plate is preferably positioned between the positive electrode and the negative electrode. Preferably, the pregel composition is poured between the positive electrode and the negative electrode and the pregel solution is impregnated into the porous plate and then the gelation is performed. The pregel composition is preferably impregnated into the positive electrode and the negative electrode in addition to the porous plate.

It is possible that the electrolyte salt compound is dissolved in a mixture comprising a compound (for example, the crosslinking agent and the polymerization initiator) which can form a network structure with the polyether polymer, the mixture is cast by the casting, the coating or the like on a substrate such as a glass substrate and a polytetrafluoroethylene substrate, and then the gelation is performed, thereafter the resultant gel electrolyte film is sandwiched between the positive electrode and the negative electrode. It is also possible that the electrolyte salt compound is dissolved in a mixture of the branched polyether polymer and the compound forming the network structure, the electrolyte solution is directly coated by the casting, the coating and the like on the positive electrode and the negative electrode equipped with a guide for preventing the flow-out of the electrolyte solution, and the electrolyte solution is gelled to forrn the electrolyte layer. In this case, when the electrolyte solution is coated on the negative electrode, the operation should be done in an inert gas or dry air atmosphere. When the lithium metal having high reactivity is used for the negative electrode, the coating is preferably done on the positive electrode since the negative electrode easily deteriorates during the operation because of, for example, corrosion of lithium.

The battery comprises (1) the positive electrode, (2) the negative electrode, (3) optionally present, the porous body, and an electrolyte structure comprising the gel electrolyte.

The battery can be obtained by injecting the polyether polymer, the crosslinking agent, the electrolyte salt compound, the aprotic organic solvent, and the polymerization initiator into the battery construction having the positive electrode and the negative electrode opposed through the porous body and then gelling the mixture by the crosslinking reaction.

Examples of the porous body include, for example, a porous film (separator), a non-woven fabric and non-woven paper made of e.g., a polyolefin resin or a fluororesin.

Since the gel electrolyte of the present invention has a sufficient ionic conductivity and an excellent mechanical property, a liquid leakage and the like are remarkably improved, the gel electrolyte of the present invention can give an electric double layer capacitor having excellent long-term stability.

An electrode material used in the present invention is preferably one having a large surface area such as active carbon. A raw material of active carbon is not limited and examples thereof include a natural organic polymer, a synthetic organic polymer and pitch. The shape of active carbon is arbitrary and may be, for example, fibrous or powder.

The capacitor comprises at least two electrodes and the electrolyte. The electric double layer capacitor of the present invention may be prepared by injecting the pregel composition (particularly the pregel solution), which is a base material of the gel electrolyte, between the electrodes and then gelling the pregel. A separator may be used when the two electrodes make a short circuit. The capacitor can be prepared by injecting the polyether polymer, the crosslinking agent, the electrolyte salt compound, the aprotic organic solvent, and the polymerization initiator into a capacitor construction and then gelling the mixture by the crosslinking reaction.

Next, the photoelectric conversion element in the present invention means an element which converts a light energy to an electric energy by the utilization of an electrochemical reaction between electrodes. When the photoelectric conversion element is irradiated with light, an electron is generated at one electrode and passes through an electrical wire provided between the electrodes to reach a counter electrode. The electron reaching the counter electrode reduces an oxidation-reduction pair in the gel electrolyte. The reduced oxidation-reduction pair migrates from one electrode to an other electrode in the form of a negative ion in the gel electrolyte to reach the other electrode, whereby the reduced oxidation-reduction pair returns to an oxidation substance to cause the electron to return to the other electrode. The photoelectric conversion element of the present invention is an element which can convert the light energy to the electric energy, and the photoelectric conversion element can be applied for, e.g., a solar battery and a photosensor.

The photoelectric conversion element comprises the gel electrolyte and a pair of (two) electrodes.

Examples of the electrode include an electrically conductive body attached to a glass plate (a transparent protective material which penetrates light). The glass plate having the electrode may be a glass plate coated with an electrically conductive material (for example, a metal, an oxide semiconductor, particularly indium-tin oxide (ITO)).

The preferable photoelectric conversion element can be prepared when the electrode is an oxide semiconductor such as titanium oxide, zinc oxide, tungsten oxide, barium titanate, strontium titanate and potassium titanate; a semiconductor such as cadmium sulfide, CdTe, silicon, phthalocyanine, polythienylene, polypyrole and polyaniline; or a material prepared by sensitizing the above-mentioned oxide semiconductor and semiconductor with a colorant or another inorganic substance, and one or at least two layers thereof are supported. That is, the photoelectric conversion element of the present invention may comprises the gel electrolyte; one electrode comprising a semiconductor (for example, n-type semiconductor or p-type semiconductor); and the counter electrode which is a semiconductor (for example, p-type semiconductor or n-type semiconductor) or a metal.

The semiconductor used for the electrode is preferably an oxide semiconductor. Particularly titanium oxide and titanium oxide sensitized with a colorant is preferable in view of stability, safety and cost. The colorant may be an organic metal complex, for example, a ruthenium-bipyridine complex, particularly cis-di(thiocyanato)-N,N-bis(2,2′-bipyridyl4,4′-dicarboxylic acid) ruthenium (II).

In order to provide the gel electrolyte on the electrode, the pregel composition, which is a base material of the gel electrolyte, can be, for example, coated directly on the electrode and gelled. After the polymer solid electrolyte is provided on one electrode, a counter electrode is positioned on the polymer solid electrolyte to give the photoelectric conversion element.

The solar battery and the optical element generally comprises the positive electrode, the negative electrode and the gel electrolyte. The solar battery and the optical element can be prepared by injecting the polyether polymer, the crosslinking agent, the electrolyte salt compound, the aprotic organic solvent, and the polymerization initiator into a photoelectric conversion element construction and then gelling them by the crosslinking reaction.

The element of the present invention can be used as a lithium battery, a capacitor, a sensor, and a photoelectric conversion element for a solar battery and a photosensor.

### PREFERRED EMBODIMENTS OF THE INVENTION

Hereinafter, the present invention is illustrated by the following Examples which do not limit the present invention. The present invention can be conducted with modifying the Examples in so far as the gist of the present invention is not changed.

### SYNTHESIS EXAMPLE 1

<Synthesis of Polyether Copolymer (I)>

The internal part of 3L four necked glass flask was replaced with a nitrogen gas. An organotin-phosphate ester condensate (as a catalyst) which was prepared by heating tributyl tin chloride (0.1 g) and tributyl phosphate (0.3 g) at 270° C. for 30 minutes, 2-(2-methoxyethoxy)ethyl glycidyl ether (300 g) having an adjusted water content of at most 10 ppm, allyl glycidyl ether (15 g) and hexane (2,000 g) (as the solvent) were charged into the flask. Ethylene oxide (75 g) was sequentially added with monitoring the polymerization degree of the glycidyl ether compounds by a gas chromatography. After the product was removed by decantation, the product was dried under reduced pressure at 40° C. for 24 hours to give a rubbery polyether copolymer (I) (360 g). The copolymer had a composition in terms of monomers measured by 1H-NMR spectrum of ethylene oxide: 2-(2-methoxyethoxy)ethyl glycidyl ether:allyl glycidyl ether=51:48:1 mol %. The copolymer was measured by a gel permeation chromatography to reveal that the weight-average molecular weight in terms of standard polystyrene was 850,000 and the distribution (Mw/Mn) was 6.3.

### SYNTHESIS EXAMPLE 2

<Synthesis of Polyether Copolymer (II)>

The internal part of 3L four necked glass flask was replaced with a nitrogen gas. An organotin-phosphate ester condensate (as a catalyst) which was prepared by heating tributyl tin chloride (0.1 g) and tributyl phosphate (0.3 g) at 270° C. for 30 minutes, 2-(2-methoxyethoxy)ethyl glycidyl ether (250 g) having an adjusted water content of at most 10 ppm, allyl glycidyl ether (25 g) and hexane (2,000 g) (as the solvent) were charged into the flask. Ethylene oxide (250 g) was sequentially added with monitoring the polymerization degree of the glycidyl ether compounds by a gas chromatography. The polymerization reaction was discontinued by methanol. After the product was removed by decantation, the product was dried under reduced pressure at 40° C. for 24 hours to give a rubbery polyether copolymer (II) (460 g). The copolymer had a composition in terms of monomers measured by 1H-NMR spectrum of ethylene oxide:2-(2-methoxyethoxy)ethyl glycidyl ether:allyl glycidyl ether=78:19:3 mol %. The copolymer was measured by a gel permeation chromatography to reveal that the weight-average molecular weight in terms of standard polystyrene was 650,000 and the distribution was 4.5.

### SYNTHESIS EXAMPLE 3

<Synthesis of Polyether Copolymer (III)>

The internal part of 3L four necked glass flask was replaced with a nitrogen gas. An organotin-phosphate ester condensate (as a catalyst) which was prepared by heating tributyl tin chloride (0.1 g) and tributyl phosphate (0.3 g) at 270° C. for 30 minutes, 2-(2-methoxyethoxy)ethyl glycidyl ether (135 g) having an adjusted water content of at most 10 ppm, glycidyl methacrylate (19 g) and hexane (2,000 g) (as the solvent) were charged into the flask. Ethylene oxide (338 g) was sequentially added with monitoring the polymerization degree of the glycidyl ether compound by a gas chromatography. The polymerization reaction was discontinued by methanol. After the product was removed by decantation, the product was dried under reduced pressure at 40° C. for 24 hours to give a waxy or plastic polyether copolymer (III) (420 g). The copolymer had a composition in terms of monomers measured by 1H-NMR spectrum of ethylene oxide:2-(2-methoxyethoxy)ethyl glycidyl ether:glycidyl methacrylate=78:19:3 mol %. The copolymer was measured by a gel permeation chromatography to reveal that the weight-average molecular weight in terms of standard polystyrene was 220,000 and the distribution was 4.1.

### EXAMPLES 1 to 12

Preparation and viscosity of pregel solution, and evaluation of gelation reactivity: Polyether copolymer (I)-(III), trimethylolpropane trimethacrylate (NK ESTER TMPT manufactured by Shin-nakamura Chemical Co., Ltd.) or N,N′-m-phenylene bismaleimide (SUMIFINE BM manufactured by Sumitomo Chemical Co., Ltd.) as a crosslinking agent, t-butyl peroxy-2-ethyl hexanoate (PERBUTYL O manufactured by NOF Corp.) as a peroxide, and 1 M-LiBF₄/EC:DMC=1:1 (vol) and 1 M-LiTFSI/EC:DEC=1:1 (vol) as an electrolyte solution were used to prepare various pregel solutions. The viscosity of the solution at 25° C. was measured by a BM-type rotary viscometer. Results are shown in Tables 1 and 2.

Herein, EC stands for ethylene carbonate; DMC stands for dimethyl carbonate, DEC stands for diethyl carbonate; and LiTFSI stands for lithium bis(trifluoromethyl sulfonyl) imide.

Evaluation of Gelation Performance

Said pregel solution was degassed in a vacuum oven for 5 minutes, and then the atmosphere was replaced with an argon gas and the crosslinking reaction was performed at 70° C. for 1 hr. After the reaction, a product was removed into an atmospheric air and cooled to the room temperature, and the state of gelation was evaluated. The evaluation was as follows:

O: Product does not deform when vessel is upside-down.

Δ: Product deforms but does not flow when vessel is upside-down.

X: Product does not gel or does flow down when vessel is upside-down.

The results are shown in Tables 1 and 2

Evaluation of Ionic Conductivity

A sample, which was observed to have the gelation in the above-mentioned gelation performance evaluation, was tested. A pregel solution from which water was eliminated was charged into an ionic conductivity measurement cell having a spacer and was crosslinked at 70° C. for 1 hour in an oven equipped in an argon glove box. A closed cell was assembled in the grove box. A complex impedance plot measurement was performed at 25° C., an applied voltage of 10 mV and a frequency range of 5 Hz to 13 MHz by an impedance analyzer to calculate an ionic conductivity σ. The results are shown in Tables 1 and 2.

Method of Preparing a Positive Electrode

85 g of LiCoO₂ powder, 12 g of acetylene black, 13 g of a polyvinylidene fluoride copolymer (manufactured by Elf Atochem) and 30 g of dimethylformamide were mixed by a disper. The mixture was coated on an aluminum foil (thickness: 25 μm) and dried in vacuum to remove the solvent. The mixture was pressed by two rolls, dried in vacuum, and stored in a glove box having argon atmosphere.

Assembly and Recharge/Discharge Test of Lithium Battery

The above-mentioned prepared positive electrode, a porous film (separator) and a lithium metal negative electrode were laminated and three edges were heat sealed with an aluminum laminate, maintaining one edge unsealed for a liquid injection port. After the above-mentioned pregel solution, from which water was eliminated, was injected from the liquid injection port, the degassing in vacuum was performed for 30 minutes. Then the open port was closed by a heat seal. The crosslinking reaction was performed 70° C. for 1 hour. The procedure of assembling the cell was performed in a glove box having argon atmosphere. The assembled cell was stored at 20° C. in a constant temperature bath for one night and then the recharge/discharge properties of the battery were determined at 20° C. In the voltage range of 2.7 V to 4.1 V, the battery was recharged under a constant current (CC) at a current density of 0.1 mA/cm² until 4.1 V and discharged until 2.7 V under a constant current (CC). The discharge capacity was measured at initial and after 100 cycles. A ratio ofthe discharge capacity after 100 cycles to the discharge capacity at initial is taken as a capacity maintenance rate (%), which is shown in Tables 1 and 2.

TABLE 1

| | Example No. | | | | | |
|---|---|---|---|---|---|---|
| | 1 | 2 | 3 | 4 | 5 | 6 |
| Polyether copolymer (I) (g) | 5 | 4 | 3 | | | |
| Polyether copolymer (II) (g) | | | | 5 | 4 | 3 |
| Polyether copolymer (III) (g) | | | | | | |
| Bismaleimide (BM) (g) | 0.5 | 0.4 | 0.45 | 0.5 | 0.4 | 0.45 |
| Trimethylolpropane | | | | | | |
| trimethacrylate (TMPT) (g) | | | | | | |
| Peroxide (g) | 0.1 | 0.1 | 0.1 | 0.1 | 0.1 | 0.1 |
| 1M-LiBF₄-EC/DMC (g) | 95 | 96 | 97 | | | |
| 1M-LiTFSI-EC/DEC (g) | | | | 95 | 96 | 97 |
| Pregel viscosity (25° C.) (mPa · s) | 75 | 55 | 38 | 50 | 35 | 22 |
| Gelation (70° C. × 1 HR) | ◯ | ◯ | ◯ | ◯ | ◯ | ◯ |
| Ionic conductivity (25° C.) | 3.1 × 10⁻³ | 3.8 × 10⁻³ | 4.2 × 10⁻³ | 5.2 × 10⁻³ | 6.5 × 10⁻³ | 7.6 × 10⁻³ |
| (S/cm) | | | | | | |
| Initial discharge capacity | 121 | 122 | 126 | 121 | 127 | 128 |
| (mAh/g-positive electrode | | | | | | |
| active material) | | | | | | |
| Capacity maintenance rate (%) | 92 | 94 | 94 | 91 | 93 | 95 |

TABLE 2

| | Example No. | | | | | |
|---|---|---|---|---|---|---|
| | 7 | 8 | 9 | 10 | 11 | 12 |
| Polyether copolymer (I) (g) | | | | | | |
| Polyether copolymer (II) (g) | | | | | | |
| Polyether copolymer (III) (g) | 5 | 4 | 3 | 2 | 10 | 5 |
| Bismaleimide (BM) (g) | 0.5 | 0.4 | 0.45 | 0.5 | | |
| Trimethylolpropane | | | | | 1 | 1 |
| trimethacrylate (TMPT) (g) | | | | | | |
| Peroxide (g) | 0.1 | 0.1 | 0.1 | 0.1 | 0.1 | 0.1 |
| 1M-LiBF₄-EC/DMC (g) | 95 | 96 | 97 | 98 | 90 | 95 |
| 1M-LiTFSI-EC/DEC (g) | | | | | | |
| Pregel viscosity (25° C.) (mPa · s) | 32 | 25 | 15 | 11 | 46 | 29 |
| Gelation (70° C. × 1 HR) | ◯ | ◯ | ◯ | Δ | ◯ | Δ |
| Ionic conductivity (25° C.) (S/cm) | 3.2 × 10⁻³ | 3.6 × 10⁻³ | 4.0 × 10⁻³ | 4.2 × 10⁻³ | 2.5 × 10⁻³ | 3.8 × 10⁻³ |
| Initial discharge capacity | 126 | 129 | 128 | 128 | 120 | 125 |
| (mAh/g-positive electrode active | | | | | | |
| material) | | | | | | |
| Capacity maintenance rate (%) | 92 | 93 | 96 | 95 | 88 | 89 |

### COMPARATIVE EXAMPLES 1 to 5

A polyether copolymer (IV) (ethylene oxide:2-(2-methoxyethoxy)ethyl glycidyl ether:allyl glycidyl ether=76:22:2 mol %, Mw=1,760,000, Mw/Mn=6.1) and polyethyleneglycol dimethacrylate (V) (average molecular weight: 226, manufactured by NOF Corp.) as a polymer material, t-butyl peroxy-2-ethyl hexanoate (PERBUTYL O manufactured by NOF Corp.) as a peroxide, and 1 M-LiBF₄/EC:DMC=1:1 electrolyte solvent (SOLULITE manufactured by Mitsubishi Chemical Corp.) as an electrolyte solution were used to prepare pregels having various compositions. In the same manner as in the above-mentioned Examples, the valuation of the viscosity, the gelation performance and the ionic conductivity, and the battery test were performed. The results are shown in Table 3.

TABLE 3

| | Comparative Example No. | | | | |
|---|---|---|---|---|---|
| | 1 | 2 | 3 | 4 | 5 |
| Polyether copolymer (IV) (g) | 5 | 3 | | | |
| Polyethylene glycol (V) (g) | | | 10 | 7 | 5 |
| Bismaleimide (BM) (g) | 0.5 | 0.3 | | | |
| Peroxide | 0.1 | 0.1 | 0.1 | 0.1 | 0.1 |
| 1M-LiBF₄-EC/DMC (g) | 95 | 97 | 90 | 93 | 95 |
| Pregel viscosity (25° C.) (mPa · s) | 170 | 110 | 16 | 13 | 10 |
| Gelation(70° C. × 1 HR) | ◯ | ◯ | ◯ | Δ | X |
| Ionic conductivity (25° C.) (S/cm) | 1.9 × 10⁻³ | 2.0 × 10⁻³ | 8.0 × 10⁻⁴ | 1.4 × 10⁻³ | — |
| Initial discharge capacity | 46 | 78 | 120 | 124 | — |
| (mAh/g-positive electrode active | | | | | |
| material) | | | | | |
| Capacity maintenance rate (%) | 80 | 82 | 67 | 74 | |

Tables 1 to 3 indicate that, although the pregel solution of the present invention has a low polymer concentration, the pregel solution exhibits sufficient gelation performance. Particularly, the use of a maleimide crosslinking agent is preferable. Accordingly, since the resultant gel electrolyte composition resembles the electrolyte solution, the resultant gel electrolyte exhibits the high ionic conductivity near about 10⁻² order at room temperature. When the gel electrolyte is incorporated into the battery, the battery exhibits excellent initial discharge capacity and cycle properties.

### EFFECT OF THE INVENTION

The gel electrolyte having high ionic conductivity of the present invention wherein the electrolyte solution is impregnated into the high molecular weight ether polymer is excellent in the property of keeping the electrolyte solution and the gelation performance and has the composition resembling the electrolyte solution, in comparison with a conventional gel electrolyte wherein a reactive monomer is polymerized in an electrolyte solution. The problem of the liquid leakage of the electrolyte solution is dissolved, and good ionic conductivity and battery performance comparable to the electrolyte solution are exhibited. The element of the present invention can be satisfactorily used as, for example, a lithium battery and a capacitor, and a photoelectric conversion element for a solar battery and a photosensor.

1. An element comprising a gel electrolyte obtained by reacting a pregel composition having a viscosity of at most 100 mPa.s at 25° C. comprising:
(A)
(i) a polyether polymer having a weight-average molecular weight of 50,000 to 1,000,000 and obtained by polymerizing at least one oxirane compound having ethylene oxide and/or propylene oxide in a main chain and optionally having a oligoalkylene oxide chain structure in a side chain, and/or
(ii) a polyether polymer having a weight-average molecular weight of 50,000 to 1,000,000 and obtained by copolymerizing at least one oxirane compound having ethylene oxide and/or propylene oxide in a main chain and optionally having a oligoalkylene oxide chain structure in a side chain, and at least one oxirane compound having a reactive functional group,
(B) a crosslinking agent,
(C) an electrolyte salt compound,
(D) an aprotic organic solvent, and
(E) a polymerization initiator, wherein the element is prepared by injecting the pregel composition into an element construction having a positive electrode and a negative electrode which are opposed, and gelling the pregel composition by a crosslinking reaction, and the gel, in which the concentration of the polyether polymer (A) is from 0.5 to 10% by weight based on the gel electrolyte, is sandwiched between the positive electrode and the negative electrode.

2. The element according to claim 1, which is a battery, a capacitor, a sensor or an optical element.

3. The element according to claim 1, wherein the optical element is a photoelectric conversion element, a solar battery or a photosensor.

4. The element according to claim 1, wherein, in the polyether polymer (A), the oxirane compound having oligoalkylene oxide chain structure is of the formula (1): 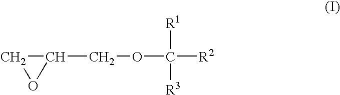
wherein R¹, R² and R³ are a hydrogen atom or —CH₂O(CH₂CH₂O)ₙR (n and R may be different among R¹, R² and R³) provided that all of R¹, R² and R³ are not simultaneously a hydrogen atom (R is a group selected from an alkyl group having 1 to 12 carbon atoms, an alkenyl group having 2 to 8 carbon atoms, a cycloalkyl group having 3 to 8 carbon atoms, an aryl group having 6 to 14 carbon atoms and an aralkyl group having 7 to 12 carbon atoms. n is from 1 to 12.)

5. The element according to claim 1, wherein the reactive functional group in the polyether polymer (A) is (a) a reactive silicon group, (b) a methyl epoxy group, or (c) an ethylenically unsaturated group.

6. The element according to claim 1, wherein the crosslinking agent (C) is a maleimide-based compound.

7. The element according to claim 1, wherein the polymerization initiator (E) is an organic peroxide or an azo compound.

8. The element according to claim 1, wherein the polymerization initiator (E) is an organic peroxide, and the organic peroxide is a peroxyester, a diacyl peroxide, a dialkyl peroxide, a hydroperoxide, a peroxy ketal and/or a ketone peroxide.

9. The element according to claim 1, wherein the element construction has a porous body between the positive electrode and the negative electrode, and the pregel composition is injected, the pregel composition is impregnated into the porous body and then the pregel composition is gelled by a crosslinking reaction.
